(19) United States
(12) Patent Application Publication
(10) Pub. No.: US 2011/0047630 A1
(43) Pub. Date: Feb. 24, 2011

(54) METHOD AND SYSTEM FOR TAMPER PROOFING A SYSTEM OF INTERCONNECTED ELECTRONIC DEVICES

(75) Inventors: Heng Seng Cheng, Singapore (SG); Huaqun Guo, Singapore (SG); Yong Dong Wu, Singapore (SG)

Correspondence Address: HARNESS, DICKEY & PIERCE, P.L.C., P.O. BOX 828, BLOOMFIELD HILLS, MI, 48303, US

(73) Assignee: Agency for Science, Technology and Research, Singapore (SG)

(21) Appl. No.: 12/449,416

(22) PCT Filed: Feb. 11, 2008
(86) PCT No.: PCT/SG2008/000049

§ 371 Date: Oct. 27, 2010

Related U.S. Application Data
(60) Provisional application No. 60/900,317, filed on Feb. 9, 2007.

(51) Int. Cl. G08B 29/00; H04L 9/00

(52) U.S. Cl. 726/34

(57) ABSTRACT

A method and system for tamper proofing a system of interconnected electronic devices. The method comprises splitting embedded software of each electronic device into at least two executable parts, a stationary part residing in memory of said each electronic device and a non-stationary part residing in memory of another electronic device.

### FIELD OF INVENTION

The present invention relates to a method and system for tamper proofing a system of interconnected electronic devices.

### BACKGROUND

An effective electronic security system is one where tampering of the electronic equipment involved by an unauthorized personnel is made so difficult that the unauthorized personnel would abandon the idea of tampering with the electronic equipment. An example of where an effective electronic security system could be used is in the prevention of automotive thefts.

Automotives can be stolen in several ways. In one way, the vehicle is forced to start and driven away. This requires the thief to gain access to the car's ignition system to start the engine by, for instance, hotwiring. Hotwiring is the process of bypassing an automobile's ignition interlock and starting the automobile without the key. If the thief lacks the skills and knowledge to hotwire a car, another way to start the car is to simply smash the key mechanism to reveal the rotation switch, which is operated by the key's tumbler. This can be accomplished with the same tool that may have been used to smash the vehicle's windows to gain access. The rotation switch can then be operated by a screwdriver or a similar tool.

Another way to steal a vehicle is to tow the vehicle away. After towing the stolen vehicle to a workshop, the thieves have all the time to dismantle the vehicle and re-sell the dismantled parts into the market or to remove the automotive security devices (e.g. an immobiliser) installed in the stolen vehicle and thereafter re-sell the vehicle with a different identity to the market.

In general, two main approaches are adopted to combat automotive thefts. In the first approach, thieves are prevented from stealing vehicles from where they are parked. An example of this approach is to use immobilisers. In the second approach, security measures are used to deter or discourage thieves from stealing vehicles, for instance, by utilizing technologies that disable a car from starting and the car's systems from activating after it is stolen.

The first approach is effective only to some extent, as it cannot prevent a thief from stealing a car by towing the car away or using a crane to lift the car onto a lorry. The second approach is more effective as thieves would end up with a car that cannot be functioning.

The immobiliser is a device that is designed to prevent thieves from stealing a car even if they have gained access to the car's ignition system. It is usually part of an electronic control unit (ECU) that prevents the car from starting unless it receives recognised signals from a transponder in the key. The immobiliser can work in several ways. A common implementation is to immobilise the starter motor, the fuel pump or the ignition system, or all of these components.

While the immobiliser can prevent a thief from starting the car engine and driving the car away, it cannot stop thieves from towing the car away. At the workshop, thieves can still dismantle the vehicle and sell the dismantled components. The thieves can also remove the immobiliser and re-sell the car using another identity.

Another existing technology for combating vehicle theft is referred to as Electronic Vehicle Identification (EVI). EVI involves establishing data communication between a vehicle and a remote registration database, and use, for instance, Radio Frequency Identification (RFID) technology, so that unique identification parameters of the vehicle can be exchanged to verify that the vehicle or vehicle part is not stolen.

EVI is efficient when it comes to identification and verification of vehicles and vehicle parts during, for example, importation or exportation of vehicles or vehicle parts, since EVI can be done conveniently via, for instance, a scanner. However, EVI is ineffective against thieves who export the stolen vehicles or the dismantled parts to countries that do not implement identification and verification of vehicles and vehicle parts using the EVI system.

Another technology for combating vehicle theft is microdots identification, which is a process where tiny laser discs etched with the vehicle's VIN (Vehicle Identification Number) number are sprayed onto the car's major mechanical parts and under body areas. About 10,000 identifying numbers are sprayed on with a clear adhesive that cannot be seen by the human eye. The fact that it is difficult to remove all the microdots in a vehicle deters thieves who would have otherwise been able to rebirth vehicles as well as sell stolen vehicle parts as legitimate ones.

While microdot identification has the advantage of being very difficult to remove, identification and verification of vehicle information is inconvenient, as verification of a microdot requires its removal for reading under a microscope. Similar to EVI, microdot identification is ineffective against thieves who export the stolen vehicles or dismantle the car parts to countries that do not practise identification and verification of vehicles and vehicle parts.

A need therefore exists to provide a method and system for tamper proofing a system of electronic devices that addresses at least one of the above-mentioned problems.

### SUMMARY

In accordance with a first aspect of the present invention there is provided a method for tamper proofing a system of interconnected electronic devices, the method comprising splitting embedded software of each electronic device into at least two executable parts, a stationary part residing in memory of said each electronic device and a non-stationary part residing in memory of another electronic device.

The method may further comprise interleaving at least one stationary part and one non-stationary part residing in memory of one electronic device at source code level; and compiling the stationary part and the non-stationary part to executable code for storing in the electronic device.

The stationary part and the non-stationary part of the split embedded software of one electronic device may communicate with each other via broadcasting communications over a network bus.

The broadcasting communications may comprise data messages, and electronic devices receiving the broadcasting communication determine whether the broadcasting communication is intended for them based on the data messages.

The data messages may be encrypted.

The method may further comprise using a secure device interconnected to the electronic devices.

The secure device may broadcast an authentication request for one of the electronic devices, and the secure device may authenticate said one device based on a broadcast authentication reply from said one electronic device.

The authentication may be based on authentication of the stationary part of the split embedded software of said one electronic device.

The secure device may assign the non-stationary part of said one electronic device residing in memory of another electronic device by sending an assignation request to said other electronic device.

Multiple copies of the non-stationary part of one electronic device may reside in respective memories of two or more other electronic devices, and the secure device may only assign and activate one copy of the non-stationary part for each assignation instance.

In accordance with a second aspect of the present invention there is provided a system for tamper proofing a system of interconnected electronic devices, the system comprising a plurality of electronic devices, wherein each electronic device comprises an embedded software, said embedded software is split into at least two executable parts, a stationary part residing in memory of said each electronic device and a non-stationary part residing in memory of another electronic device.

At least one stationary part and one non-stationary part residing in memory of one electronic device may be interleaved at source code level, and the stationary part and the non-stationary part compiled to executable code are stored in the electronic device.

The stationary part and the non-stationary part of the split embedded software of one electronic device may communicate with each other via broadcasting communications over a network bus.

The broadcasting communications may comprise data messages, and electronic devices receiving the broadcasting communication determine whether the broadcasting communication is intended for them based on the data messages.

The data messages may be encrypted.

The system may further comprise a secure device interconnected to the electronic devices.

The secure device may broadcast an authentication request for one of the electronic devices, and the secure device may authenticate said one device based on a broadcast authentication reply from said one electronic device.

The authentication may be based on authentication of the stationary part of the split embedded software of said one electronic device.

The secure device may assign the non-stationary part of said one electronic device residing in memory of another electronic device by sending an assignation request to said other electronic device.

Multiple copies of the non-stationary part of one electronic device may reside in respective memories of two or more other electronic devices, and the secure device may only assign and activate one copy of the non-stationary part for each assignation instance.

In accordance with a third aspect of the present invention there is provided an automotive comprising the system as defined in the second aspect.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a plurality of Electronic Control Units with divided embedded software in a Controller Area Network Bus according to an example embodiment of the present invention.

FIG. 2 shows a plurality of Electronic Control Units with interleaved software in a Controller Area Network according to an example embodiment of the present invention.

FIG. 3 illustrates authentication of an Electronic Control Unit in a Controller Area Network according to an example embodiment of the present invention.

FIG. 4 illustrates assignment of intermediate nodes for communication between Electronic Control Units in a Controller Area Network according to an example embodiment of the present invention.

FIG. 5 illustrates hiding of active Electronic Control Units in a Controller Area Network according to an example embodiment of the present invention.

FIG. 6 illustrates sending of messages between ECUs in a Controller Area Network with two intermediate nodes according to an example embodiment of the present invention.

FIG. 7 illustrates sending of messages between ECUs in a Controller Area Network with one intermediate node according to an example embodiment of the present invention.

FIG. 8 illustrates sending of messages between ECUs in two Controller Area Networks according to an example embodiment of the present invention.

FIG. 9 shows an implementation of an example embodiment of the present invention.

FIG. 10 is a flowchart of the operation of the implementation in FIG. 9.

FIG. 11 illustrates Electronic Control Units in a Controller Area Network interacting with an external server according to an example embodiment of the present invention.

FIG. 12 illustrates a schematic drawing of an electronic device for implementing the method and system according to the example embodiment.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred; combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

Example embodiments of the present invention seek to reduce the economic returns of professional automotive thieves by increasing their operating costs and increasing the likelihood of their activities being detected.

For illustration purposes, example embodiments herein described are based on automotives that have electronic control units (ECUs) interconnected by a network bus or buses. In particular, the example embodiments are based on ECUs connected by one or more Controller Area Network (CAN) Buses in an automotive.

CAN is widely used in drive-by-wire automotives where mechanical and hydraulic linkages are replaced by wires and electronic circuitries. CAN is a serial communication bus standard for connecting electronic control units (ECUs) in an automotive. CAN was specifically designed to be robust in electromagnetically noisy environments and can utilise a differential balanced line like RS-485. Although initially created for automotive purposes (as a vehicle bus), CAN is now used in many embedded control applications (e.g., industrial) that may be subject to noise. A Controller Area Network is made up of a number of CAN nodes where each CAN node is an electronic circuit implementing CAN protocol. CAN is a broadcast communication network. Every CAN protocol frame containing data (hereinafter known as “CAN frame”) transmitted from a CAN node is broadcasted to all devices connected to the CAN bus. All the devices connected to the CAN bus can receive and read the CAN frame to decide whether the data is relevant to them. The CAN protocol does not require CAN nodes to have fixed addresses. Instead, data identifiers are used in place of sender and destination addresses in the CAN frames to identify the frames being sent. In example embodiments herein described, a CAN node is connected to each ECU, which controls a system of the automotive (e.g. engine, ignition system, braking system).

In the description as follow, it is appreciated that the use of “send”, “sent”, “sending”, “transmitted”, “transmit”, “transmitting” or similar terms along with data or data messages, e.g. send data, is understood to be a broadcast of one or more CAN frames containing the data messages or data in a CAN Bus by an electronic device connected to the CAN Bus.

Before detailing the features of example embodiments of the present invention, it is worth mentioning that some security technologies in other fields, for instance, a wireless sensor network, cannot be simply deployed in electronic control units (ECUs) interconnected via a communication bus or buses to provide automotive security.

“T. Park and G. S. Kang, “Soft Tamper-Proofing via Program Integrity Verification in Wireless Sensor Networks”, IEEE Transactions on Mobile Computing, Vol. 4, No. 3, May/June 2005″ proposes a Program-Integrity Verification (PIV) protocol that is meant for wireless sensor network. In T. Park and G. S. Kang, the PIV protocol verifies the integrity of the program residing in each sensor device whenever a device joins the network or has experienced a long service blockage. The essence of the PIV protocol is the novel randomized hash function that is tailored for low-cost Central Processing Units, in which the algorithm for hash computation on the program can be randomly generated whenever the program needs to be verified. By realizing the randomized hash function, PIV can 1) prevent manipulation/reverse-engineering/re-programming of the sensor devices unless the attacker modifies the sensor hardware (e.g. by attaching more memory), 2) provide purely software-based protection, and 3) trigger program verification infrequently, thus incurring minimal intrusiveness into normal sensor functions.

However, PIV can be easily defeated should it be used in an automotive environment, where ECUs in the automotive may not be memory limited. If PIV is used in the ECUs of an automotive, an attacker may keep a copy of the unmodified software in the memory of the ECU and add in an additional copy of modified or tampered software. The unmodified software can be used to respond to the queries of the PIV protocol while the tampered software can be put into operation with the anti-theft security feature removed. As such, thieves may circumvent electronic security features of an automotive by modifying the information stored in the automotive.

Example embodiments of the present invention herein described use a method referred to herein as Distributed Computing with Non-Stationary Code Obfuscation to improve tamper resistance of ECUs connected in a CAN.

An example embodiment of the present invention consists of a secure device, herein referred to as a Tamper-Proof Unit (TPU), connected with a plurality of ECUs in a CAN. The TPU is used for authenticating the authenticity of the ECUs in the CAN and for assigning intermediate ECUs for data communication between ECUs. It is appreciated that the TPU can be an external computer server communicating with an on-board communication unit in the automotive via Global System for Mobile Communications (GSM), third generation of developments in wireless technology (3G), Worldwide Interoperability for Microwave Access (WiMax) or the like. One or a few of the existing ECUs in the CAN may also be configured to operate as a TPU. The TPU can also be a separate hardware module connected internally, i.e. on board the automotive, to the CAN Bus. On-board TPU is a TPM (Tamper Proof Module) chip or software obfuscation makes on-board TPU tamper proof. Any attempt to read the content of the TPU must be detected causing the TPU to take action to destroy the content in the TPU.

In the example embodiment, the software of each ECU in the CAN is divided into two executable parts. The first executable part, referred to as the Stationary Code, remains in the ECU. The second executable part, referred to as the Non-Stationary Code, is re-located to other ECUs. For example, the Stationary Code consists of functions handling the sensors, switches and relays found in the automotive. The Non-Stationary Code, for example, performs the function of communication. It is appreciated that the embedded software may be divided into more than two parts.

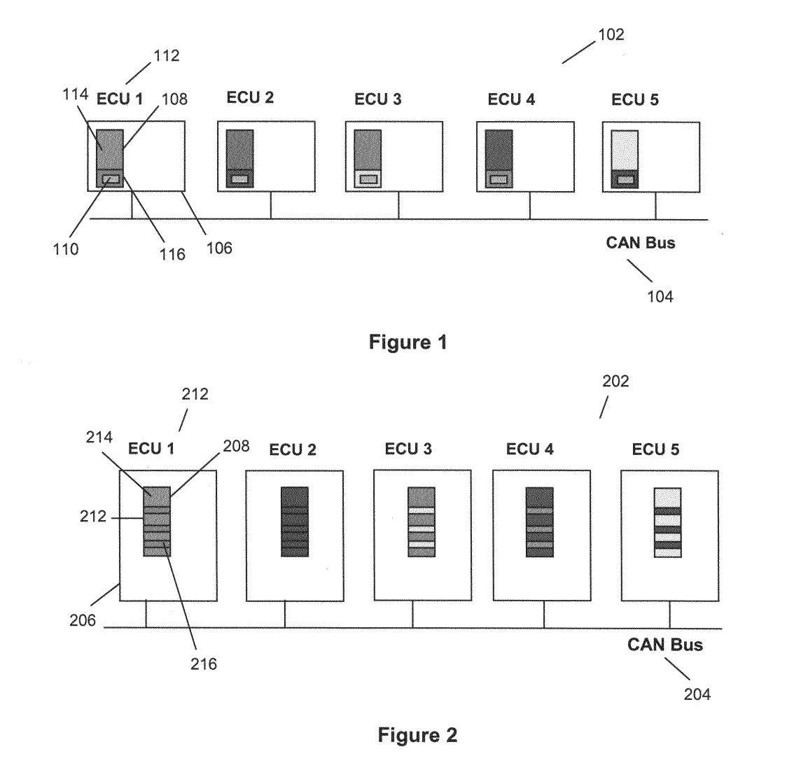

In FIG. 1, a plurality of ECUs 102 is connected to a CAN Bus 104. The embedded software of the ECUs 102 are divided into two parts. The memory 106 of an ECU 112 is installed with embedded software 108. The embedded software 108 is divided into a Stationary Code part 114 and a Non-Stationary Code part 116. The Stationary Code 114 belongs to ECU 112 but the Non-Stationary Code 116 belongs to another ECU. A software module 110 for operating anti-theft security features for the other ECU is embedded within the Non-Stationary Code 116. The embedded software in every other ECU in FIG. 1 is structured similar to ECU 112.

In the memory of each ECU of the example embodiment, the Stationary Code of the ECU is interleaved with the Non-Stationary Code of another ECU so that an adversary, e.g. a thief, would find it difficult to understand the program code installed in the memory of the ECU. In the example embodiment, to make it more difficult for the adversary to understand/erase any software from the memory of an ECU, interleaving is performed at the source code level. Then, the source code is compiled into executable code to store in the memory of ECU.

For illustration purposes, FIG. 2 shows a plurality of ECUs 202 connected to a CAN Bus 204. The Stationary Code of each ECU is interleaved with the Non-Stationary Code of another ECU residing in its memory. The memory 206 of an ECU 212 is installed with embedded software 208. The embedded software 208 is divided into a Stationary Code part 214 and a Non-Stationary Code part 216. The Stationary Code 214 is interleaved with the Non-Stationary Code part 216. The embedded software in every other ECU in FIG. 2 is structured similar to ECU 212.

Also, in the example embodiment, all Stationary Codes need to be authenticated using unique IDs (Key) by the TPU before they are activated for use. Each ECU has a unique key or ID, which is used by the TPU, to authenticate the ECU during the starting of the automotive. All the unique keys are pre-stored in the memory of the TPU.

In the example embodiment, the Non-Stationary Codes can be encrypted. To decrypt the Non-Stationary Code, the key associated with the Non-Stationary. Code is sent by the TPU to the ECU where the Non-Stationary Code resides. The keys to decrypt the Non-Stationary Codes can be pre-stored in the memory of the TPU. The encrypted Non-Stationary Code residing in an ECU is operational only after it is decrypted.

In addition, for extra security, all data messages contained in CAN frames, which are transferred between the ECUs and between the ECUs and the TPU, are encoded or encrypted prior to transmission and decoded or decrypted upon receipt. The coding or encryption scheme can be any one of ECC (Elliptic Curve Cryptosystem), RSA algorithm, etc.

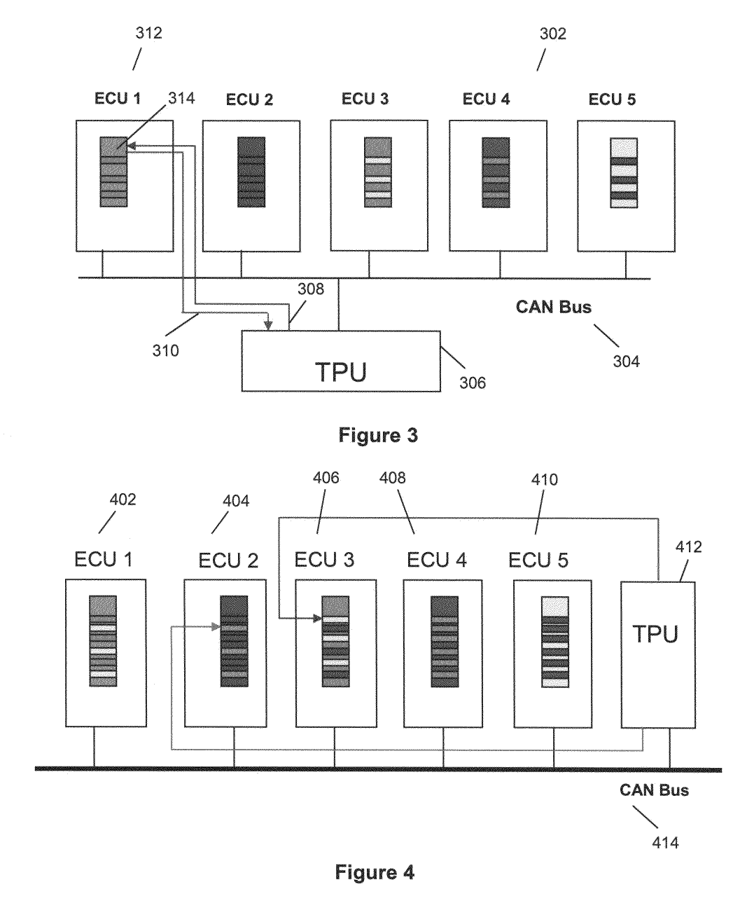

FIG. 3 illustrates the authentication of Stationary Codes in ECUs during the starting of a vehicle. A plurality of ECUs 302 and a TPU 306 are connected to a CAN Bus 304. During authentication, the TPU 306 sequentially broadcasts CAN frames containing authentication challenges to the CAN Bus. Every ECU connected to the CAN Bus will receive the authentication challenges. Each authentication challenge message is encrypted by a key associated with an ECU to be authenticated. When one of the ECU receiving an authentication challenge is capable of decrypting the challenge message and responds with broadcasting a CAN frame containing a right message, authentication for the ECU is considered successful. For further protection, all the data messages, which are transferred between the ECUs 302, and between the ECUs 302 and the TPU 306, are encoded or encrypted as mentioned above.

In FIG. 3, the Stationary Code of ECU 312 is to be authenticated. TPU 306 broadcasts a CAN frame containing an encoded authentication challenge E(r, k1) 308, which contains a unique key, k1, associated with the Stationary Code 314 of ECU 312 to the CAN Bus 304. E(r, k1) is a function of encryption where “r” stands for a challenge message, for example a random number. Upon receiving and decoding the authentication challenge 308 successfully, the ECU 312 broadcasts a CAN frame containing a reply message 310, r+1, directed to the TPU 306. “r+1” represents a response message. Upon receiving the reply message 310 and noting that authentication of the Stationary Code 314 of ECU 312 has been successful, the TPU 306 broadcasts another CAN frame containing a challenge, which contains a unique key associated with a Stationary Code of another ECU to be authenticated. If within a specified time period, no reply from the ECU 312 is received by the TPU 306 after the TPU 306 sends the challenge E(r, k1), or the ECU 312 returns an unsuccessful reply, ECU 312 will cease to function and the vehicle cannot be started because of the non functioning ECU 312.

The example embodiment is further capable of hiding the identity of the ECU, which an active Non-Stationary Code is residing, from an eavesdropper tapping into the CAN. The example embodiment accomplishes this by storing several identical copies of the Non-Stationary Code of a particular ECU in different ECUs and making only one of the identical Non-Stationary Codes active when someone starts the automotive. The TPU is responsible for assigning one of the identical copies of the Non-Stationary Code of a particular ECU that are residing in other ECUs to interact with the Stationary Code of the particular ECU. Only an assigned and activated Non-Stationary Code of an ECU can interact with the Stationary Code of the same ECU. In the next starting of the automotive, a different copy of the same Non-Stationary Code residing on another ECU is assigned. It is appreciated that the assignment information can be pre-stored in the memory of the TPU or randomly generated at the TPU.

FIG. 4 illustrates the assignment procedure of a TPU. In FIG. 4, there is an automotive with five ECUs, i.e. ECU 402, ECU 404, ECU 406, ECU 408, ECU 410, and a TPU 412 connected to a CAN Bus 414. All the data messages, which are transmitted between the ECUs, and between the ECUs and the TPU 412, are encoded or encrypted as mentioned above. Also, all the Non-Stationary Codes residing in the ECUs are encrypted.

It is assumed that authentication of the Stationary Codes of the five ECUs has been successful. It is also assumed that several identical copies of the Non-Stationary Code of each particular ECU are pre-stored in the memory of other ECUs. As mentioned above, only one of the identical Non-Stationary Codes will be assigned and activated for data communication when someone starts the automotive.

When someone starts the automotive in a first instance and authentication of the Stationary Codes of the five ECUs has been successful, the five ECUs will start to interact with one another, as they would normally do during the normal operation of the vehicle.

The TPU 412 in a first instance assigns the Non-Stationary Code (of ECU 402) stored in ECU 404 to interact with the Stationary Code of ECU 402 by broadcasting a CAN frame containing coded data instructing the activation of Non-Stationary Code (of ECU 402) in ECU 404. All the electronic devices connected to the CAN Bus 414, i.e. the five ECUs and the TPU 412, will receive the CAN frame. Upon receiving the CAN frame, every electronic device will decode the data to read its content by applying the same decoding algorithm, and decide whether the data content is intended for it. The data content also contains a key associated with the Non-Stationary Code (of ECU 402). The ECU for which the data content is intended (e.g. ECU 404) will then decrypt the Non-Stationary Code (of ECU 402) residing in it. Successful decryption further confirms that ECU 404 has not been tampered with. Once decrypted, the Non-Stationary Code (of ECU 402) has been successfully activated for use.

Similarly, the TPU 412 assigns the Non-Stationary Code (of ECU 410) stored in ECU 406 to interact with the Stationary Code of ECU 410 by broadcasting a CAN frame containing data instructing the activation of Non-Stationary Code (of ECU 410) in ECU 406. The activation of Non-Stationary Code (of ECU 410) in ECU 406 is similar to the activation of Non-Stationary Code (of ECU 402) in ECU 404 as mentioned above.

Based on the assignment, e.g. broadcasted CAN frames containing data messages directed from ECU 410 to ECU 402 are sent firstly from Stationary Code of ECU 410 to Non-Stationary Code (of ECU 410) stored in ECU 406, then secondly from Non-Stationary Code (of ECU 410) stored in ECU 406 to Non-Stationary Code (of ECU 402) stored in ECU 404, and thirdly from Non-Stationary Code (of ECU 402) stored in ECU 404 to Stationary Code of ECU 402.

In a second instance, someone starts the automotive again and authentication of the Stationary Codes of the five ECUs has been successful. In the second instance, the TPU 412 assigns the Non-Stationary Code (of ECU 402) stored in a different ECU, e.g. ECU 408, from that assigned in the first instance to interact with the Stationary Code of ECU 402 by broadcasting a CAN frame containing data instructing the activation of Non-Stationary Code (of ECU 402) in ECU 408. The activation of Non-Stationary Code (of ECU 402) in ECU 408 is similar to the activation of Non-Stationary Code (of ECU 402) in ECU 404 as mentioned above.

Similarly, the TPU 412 assigns the Non-Stationary Code (of ECU 410) stored in a different ECU, e.g. ECU 402, from that assigned in the first instance to interact with the Stationary Code of ECU 410 by broadcasting a CAN frame containing data instructing the activation of Non-Stationary. Code (of ECU 410) in ECU 402. The activation of Non-Stationary Code (of ECU 410) in ECU 402 is similar to the activation of Non-Stationary Code (of ECU 402) in ECU 404 as mentioned above.

Based on the assignment for the second instance, e.g. broadcasted CAN frames containing data messages directed from ECU 410 to ECU 402 are sent firstly from Stationary Code of ECU 410 to Non-Stationary Code (of ECU 410) stored in ECU 402, then secondly from Non-Stationary Code (of ECU 410) stored in ECU 402 to Non-Stationary Code (of ECU 402) stored in ECU 408, and thirdly from Non-Stationary Code (of ECU 402) stored in ECU 408 to Stationary Code of ECU 402.

To protect against hackers eavesdropping on the CAN Bus to see which Non-Stationary Codes have been assigned at the starting of the automotive, the example embodiment uses a network such as CAN and encrypts of all data messages contained in CAN frames that are broadcasted in the CAN bus. Eavesdroppers cannot tell which device or devices in the CAN a CAN frame containing a data message is meant for because every device receives the same CAN frame and the data message is encrypted. Furthermore, due to the use of data identifiers instead of sender and destination addresses for frame identification in CAN, there is no indication from the data identifier which is the target device or devices the data message is directed to.

It is appreciated that other networks other than CAN that do not require nodes to have fixed addresses and uses data identifiers, or the like, for frame identification can also be used by the example embodiment.

The example embodiment can further protect against hackers attempting to guess the ECU being assigned by removing the ECU from the CAN Bus to see the resultant effect. This can be achieved by making the TPU authenticate the Stationary Codes and/or re-assigning Non-Stationary Codes frequently.

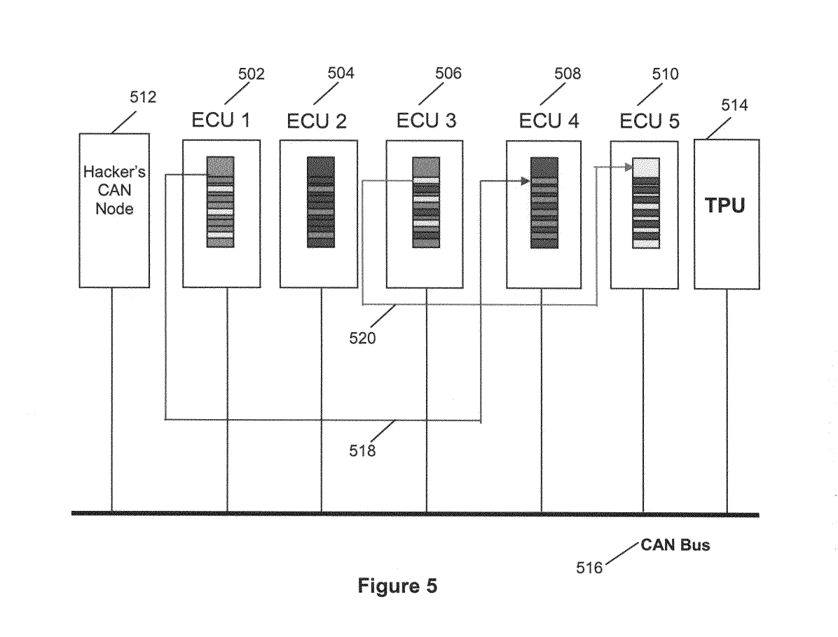

FIG. 5 illustrates how the identity of an ECU 508, which an active Non-Stationary Code is residing, is hidden from eavesdroppers. In FIG. 5, there is an automotive with five ECUs, i.e. ECU 502, ECU 504, ECU 506, ECU 508, ECU 510, a Hacker's CAN node 512 and a TPU 514 connected to a CAN Bus 516. All the data messages, which are transferred between the ECUs, and between the ECUs and the TPU 514, are encoded or encrypted prior to transmission and decoded or decrypted upon receipt. It is assumed that authentication of the Stationary Codes of the five ECUs has been successful and assignment of Non-Stationary Codes has already taken place.

ECU 502 is directing a data message contained in a CAN frame 518 to active Non-Stationary Code of ECU 502 residing at ECU 508. As the assignment of the active Non-Stationary Code 502 is kept unknown due to broadcast communication in CAN and encryption of data messages, and CAN frames do not reveal information of the sender and destination CAN nodes, the Hacker's CAN node 512 cannot find out from the CAN frame 518 that ECU 508 is the ECU reading the data message where the Non-Stationary Code of ECU 502 resides by listening to the CAN Bus 516.

The same applies if active Non-Stationary Code of ECU 510 residing at ECU 506 is broadcasting data message contained in a CAN frame 520 directed to Stationary Code of ECU 510. As the assignment of the active Non-Stationary Code is kept unknown due to broadcast communication in CAN and encryption of data messages, and CAN frames do not reveal information of the sender and destination nodes, the Hacker's CAN node 512 cannot find out from the CAN frame 520 that ECU 506 is the ECU directing the data message for ECU 510 by listening to the CAN Bus 516.

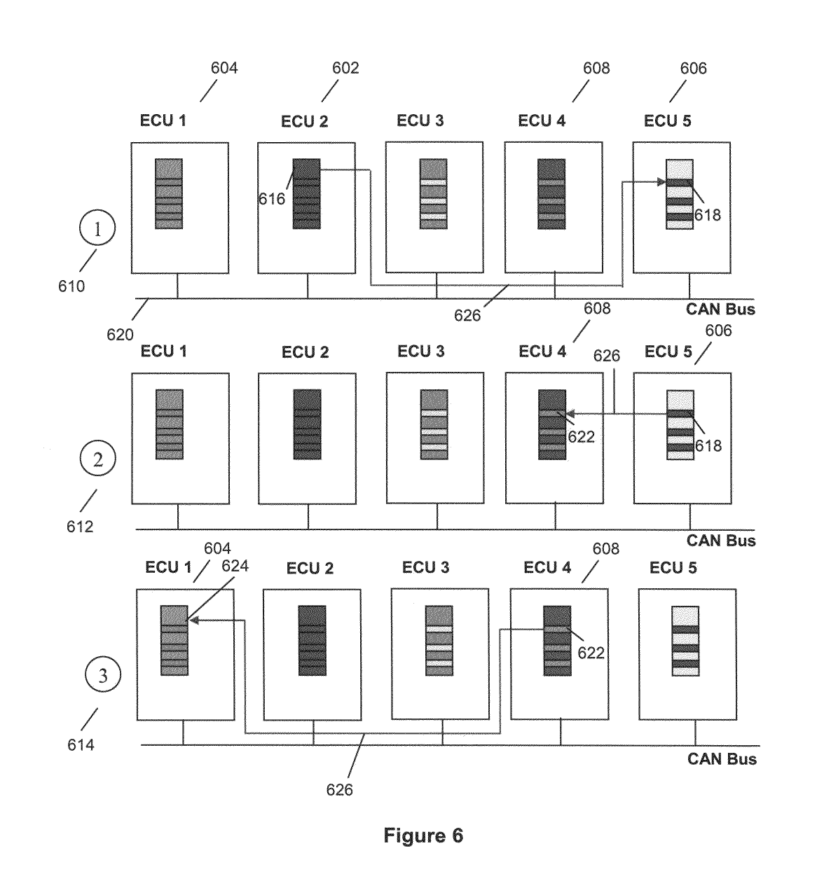

FIG. 6 illustrates the communication process between ECUs in the example embodiment after the Stationary Codes of the ECUs have been successfully authenticated and the Non-Stationary Codes of the ECUs have been assigned by a TPU.

In FIG. 6, an ECU 602 (sender node) sends a data message 626 to another ECU 604 (destination node) via a CAN Bus 620. Instead of sending the CAN frame 626 directly to ECU 604, ECU 602 sends the message 626 via ECU 606 and ECU 608. The data message 626 is deliberately sent via two intermediate CAN nodes, i.e. ECUs 606, 608, before reaching its destination ECU, i.e. ECU 604.

Data communication between the two different ECUs 602 and 604 only takes place between the respective Non-Stationary Codes 618 and 622 of the two ECUs 602 and 604. Non-Stationary Codes 618 and 622 of the two ECUs 602 and 604 respectively, reside in the memory of ECU 606 and ECU 608 respectively, are previously assigned by a TPU (not shown in FIG. 6) and activated for data communication.

At a first time instance 610, the Stationary Code 616 of ECU 602 (sender node) generates and sends a data message 626 directed to an active Non-Stationary Code 618 of ECU 602 residing at ECU 606. Thereafter, at a second time instance 612, the active Non-Stationary Code 618 of ECU 602 residing at ECU 606 sends the data message 626 to an active Non-Stationary Code 622 of ECU 604 residing at ECU 608. Finally, at a third time instance 614, the active Non-Stationary Code 622 of ECU 604 residing at ECU 608 sends the data message 626 to the Stationary Code 624 of ECU 604 (destination node).

The advantage for data messages to be communicated via Non-Stationary Codes is to ensure that even if an adversary manages to tamper an ECU and remove any anti-theft software from the embedded software in the ECU, the ECU will not be able to interact with other ECUs. This effectively disables the tampered ECU, as it is normal for a CAN-enabled ECU to communicate with other ECUs during normal operations of the automotive.

In the example embodiment, sending data messages from ECU 602 to ECU 604 incur time delays caused by time taken to send through more ECUs and additional processing at the two intermediate nodes, i.e. ECUs 606 and 608. While this delay is negligible, performance of the example embodiment can be further improved by reducing this delay. This can be achieved by reducing the number of intermediate CAN nodes to just one and making the intermediate CAN node contain the Non-Stationary Codes of both the transmitting and receiving CAN nodes.

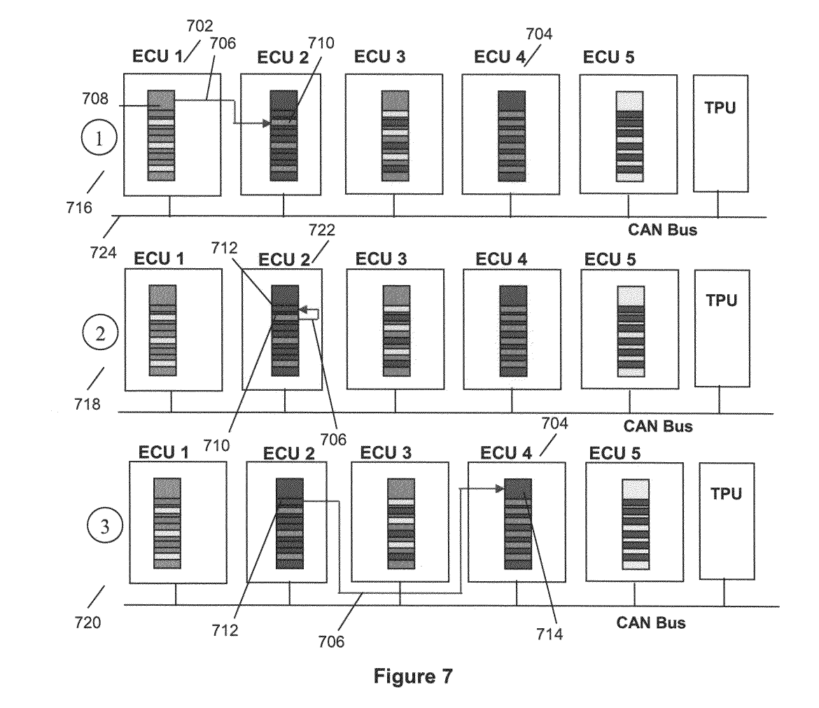

FIG. 7 illustrates the case whereby the number of intermediate CAN nodes is reduced to just one. In this example, ECU 702 is sending a data message 706 to ECU 704 via CAN Bus 724.

At a first time instance 716, the Stationary Code 708 of ECU 702 sends the data message 706 to an active Non-Stationary Code 710 of ECU 702 residing at ECU 722. Thereafter, at a second time instance 718, the active Non-Stationary Code 710 of ECU 702 residing at ECU 722 sends the data message 706 to an active Non-Stationary Code 712 of ECU 704 also residing at ECU 722. Finally, at a third time instance 720, the active Non-Stationary Code 712 of ECU 704 residing at ECU 722 sends the data message 706 to the Stationary Code 714 of ECU 704.

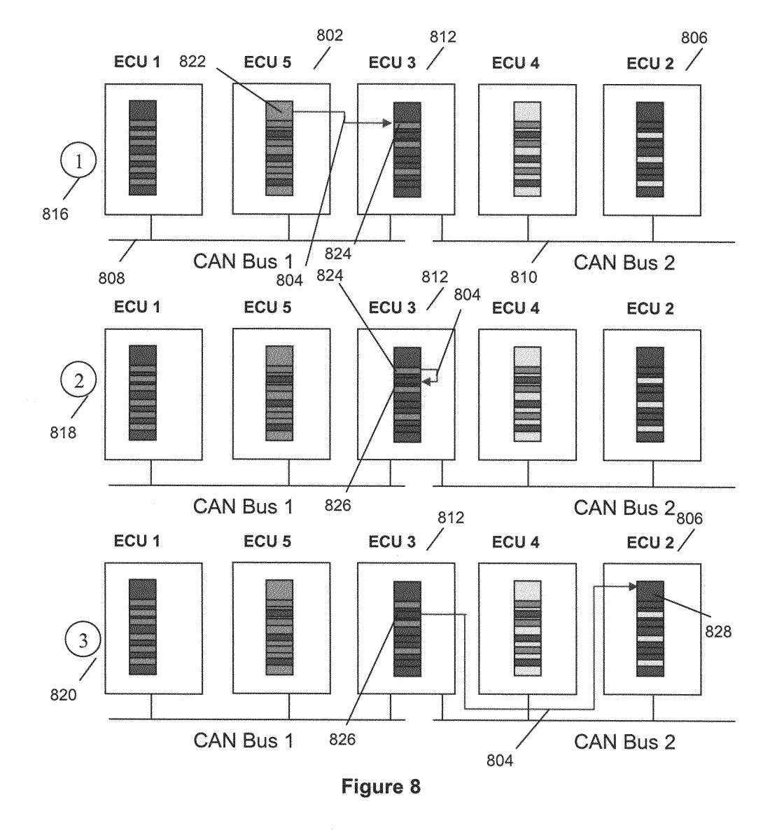

FIG. 8 illustrates an improvement to the example embodiment that can protect against concurrent tampering of two communicating ECUs. For example, a hacker may replace two ECUs or rewrite the code of two ECUs concurrently. Such protection becomes useful for situations where two tampered ECUs, by themselves, are able to achieve some functions in the automotive. Said protection is achieved by placing two ECUs e.g. two which frequently communicate with each other, in separate CAN Buses in the same automotive. The time duration to transfer data messages between the CAN Buses is set appropriately such that it would not exceed the required time limit that will slow down the system.

In FIG. 8, ECU 802 needs to send a data message 804 to ECU 806. ECU 802 is connected to a first CAN Bus 808 and ECU 806 is connected to a second CAN Bus 810. An ECU 812 is connected to both CAN Bus 808 and CAN Bus 810. ECU 812 acts as an intermediate node to send data messages transmitted from ECU 802 to ECU 806.

At a first time instance 816, the Stationary Code 822 of ECU 802 sends the data message 804 to an active Non-Stationary Code 824 of ECU 802 residing at ECU 812. Thereafter, at a second time instance 818, the active Non-Stationary Code 824 of ECU 802 residing at ECU 812 sends the data message 804 to an active Non-Stationary Code 826 of ECU 806 also residing at ECU 812. Finally, at a third time instance 820, the active Non-Stationary Code 826 of ECU 806 residing at ECU 812 sends the data message 804 to the Stationary Code 828 of ECU 806.

As ECU 802 and ECU 806 are placed in different CAN Buses, tampering them concurrently will not allow them to function properly since they still need to interact through a third party, ECU 812. The tamper resistance can be further improved by having three or more CAN Buses and placing two ECUs that exchange messages in CAN Buses such that their message has to traverse more CAN Buses.

The example embodiment can be further improved to prevent the single intermediate node ECU 812 from exposing its role as the relay node by connecting two or more intermediate nodes to both CAN Buses 808 and 810. The TPU in this case will assign one of the intermediate nodes as the relay node when the ECUs connected in CAN Bus 808 need to send messages to ECUs connected in CAN Bus 810 and vice versa.

In another example embodiment, tamper resistance is further improved by setting a “self destruct” response in the case of tampering. For instance, after tampering has been detected, for instance, upon receiving an unsuccessful authentication of Stationary Code, the TPU can immediately zeroise i.e. delete all sensitive data, e.g. assignment information and list of keys for decrypting and activating Stationary and Non-Stationary Codes, so that attackers cannot launch another attack to the CAN. Once sensitive data stored in the TPU is zeroised, the TPU becomes useless and has to be replaced or reprogrammed by the manufacturer or at its authorised service centre. This “self destruct” response can be implemented as one of the software measures to improve the tamper resistance in the TPU.

In the example embodiments herein described, additional time delay is incurred due to increased data message transmission between the CAN nodes and additional processing at the CAN nodes. However, the maximum size of any CAN frame will not be more than 150 bits. In an automotive environment where the data speed is 1 Mbit/second, it will take not more than 0.15 milliseconds to transfer a CAN frame of the largest size. In a conservative estimate, the worst-case message response time of ECUs will be assumed to be 10 times of the amount of time required to transfer a largest size CAN frame which is 1.5 milliseconds. This is negligible when compared to the amount of time taken for a driver to respond to an emergency situation on the road. The Department of Physics at Taiwan Normal University has pointed out in a research that the default value used for estimating the average reaction time of a driver is 0.5 seconds. Therefore, a message response of 1.5 milliseconds is only 0.3% of the average reaction time of a driver. As such, the time delay caused by the example embodiments herein described is well within acceptable range.

It is appreciated that in another example embodiment of the present invention, all the Non-Stationary Codes of the ECUs are stored in the memory of the TPU. In this case, the TPU is utilized as the intermediate node for all exchanges of messages between ECUs. This embodiment works on the basis that it is secure to have all the Non-Stationary Codes of the ECUs stored at the TPU by virtue that the TPU is a Tamper Proof Unit.

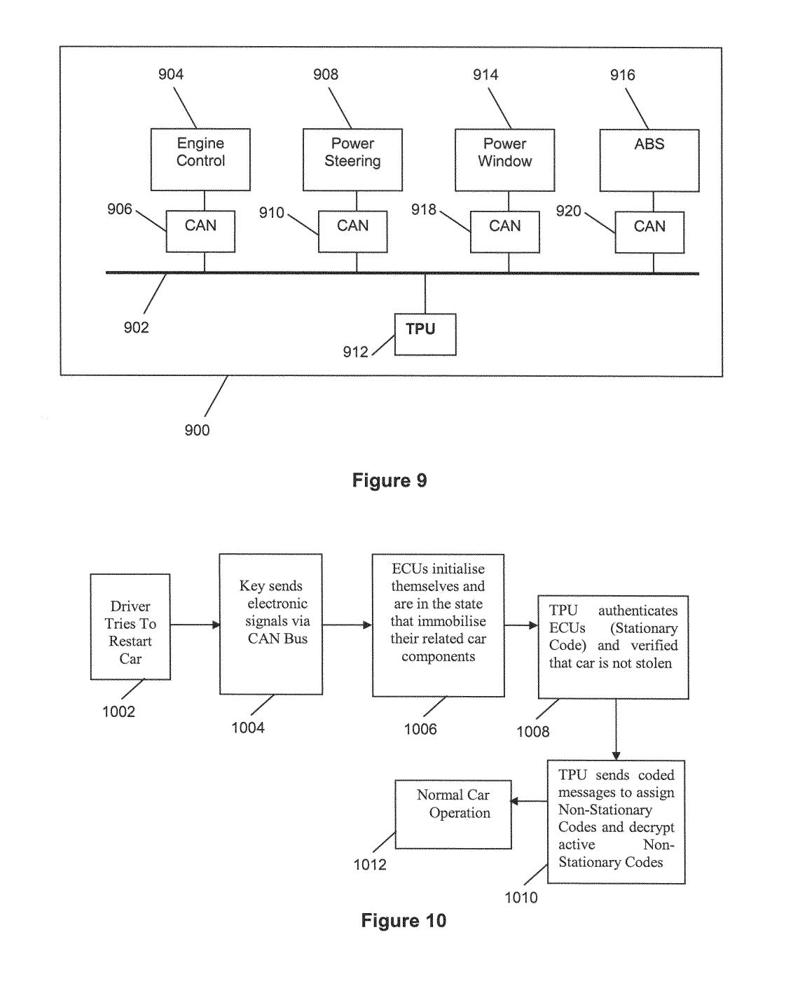

FIG. 9 further illustrates the example embodiment. In FIG. 9, there is a car 900 containing a plurality of ECUs interconnected by a CAN Bus 902. Each ECU of the car is connected to a CAN node, which is in turn connected to the CAN Bus 902. For instance, the Engine Control ECU 904 is connected to a CAN node 906 and the Power Steering ECU 908 is connected to CAN node 910. The ECUs of other auto parts, such as, 914, 916 for “Power Window”, “ABS” respectively are connected to the CAN Bus 902 via their respective CAN nodes 918, 920 in a similar fashion. An on-board TPU 912, is connected with the ECUs in the CAN Bus 902.

In FIG. 9, each ECU can only send and receive messages to and from other ECUs or TPU 912 through its own Non-Stationary Code residing in other ECUs and only an assigned Non-Stationary Code and the Stationary Code of the same ECU can send and receive messages from one another. The TPU 912 is responsible for assigning the Non-Stationary Code.

With reference to FIGS. 9 and 10, the starting operation of the car 900 in FIG. 9 can be summarized as follow.

At step 1002, a driver starts the car 900 by inserting a car key into the ignition system, which is linked to the CAN node 906.

Once the car's electrical components are powered up after turning the key, the key sends an electronic signal via the CAN Bus 902 from the CAN node 906 to all the other ECUs at step 1004.

The electronic signal triggers the ECUs to initialise themselves at step 1006. This step of initialization brings the ECUs into a state whereby they are ready to immobilise their related car components.

At step 1008, the TPU 912 authenticates the Stationary Codes of the initialised ECUs to verify that the car 900 and the ECUs are not stolen or tampered with according to the manner illustrated in FIG. 3. If within a specified time period, no reply from an ECU being authenticated is received by the TPU 912 after the TPU 912 sends an authentication challenge containing a key associated with the ECU being authenticated, or the ECU returns an unsuccessful decryption reply, the ECU will not be authenticated and the vehicle cannot be started because of the non functioning ECU.

If all of the ECUs are authenticated successfully at step 1008, the TPU 912 sends coded data messages to assign Non-Stationary Codes for data communication between the ECUs at step 1010. Since all the Non-Stationary Codes are initially encrypted, the TPU 912 will encrypt the message along with the key associated with the assigned Non-Stationary Code and broadcast the cipher text to the ECUs. In this case, only the assigned Non-Stationary Code is decrypted. Once decrypted, the assigned Non-Stationary Code becomes operational for data communication.

After the assigned Non-Stationary Codes are operational at step 1010, the car is started and normal car operation commences at step 1012.

The example embodiment described above modifies ECU software to operate as one integrated software solution that is more difficult to understand by unauthorised parties and makes it more difficult for unauthorised parties to modify ECUs to make them function normally. In doing so, the example embodiment advantageously improves tamper resistance against attempts to remove any anti-theft security software installed in the ECUs.

In another example embodiment of the present invention, automotives are protected by using remote control to disable the automotives. In this case, part of the control of the automotive and its auto parts is transferred to an external TPU, which can be a computer server connected to the Internet. The external TPU is tamper proof in the sense that it is not present in the automotive for a thief to tamper with and it can be protected by Internet security means. The external TPU can be hosted in the home of the automotive's owner or in an operation centre, which can provide the external automotive control as a service to many automotive owners. The external TPU can also remotely activate/deactivate the automotive or auto part that has been stolen via wireless communication technologies such as Global System for Mobile Communications (GSM), third generation of developments in wireless technology (3G) or Worldwide Interoperability for Microwave Access (WiMax) by transmitting activation/deactivation signals to the ECUs of the automotive.

In such an example embodiment, the identities of the automotive and its main auto parts are verified before allowing the automotive to start. Each time the driver wants to start the automotive, the ECUs connected to the CAN in the automotive will request permission from the external TPU to activate via an intermediate CAN node. This intermediate CAN node is a dedicated ECU for radio communications or a communication device such as a mobile phone, or the like. It is appreciated that the verification process can be applied in place of the authentication of Stationary Codes described with reference to FIG. 3, or happen before or after the authentication.

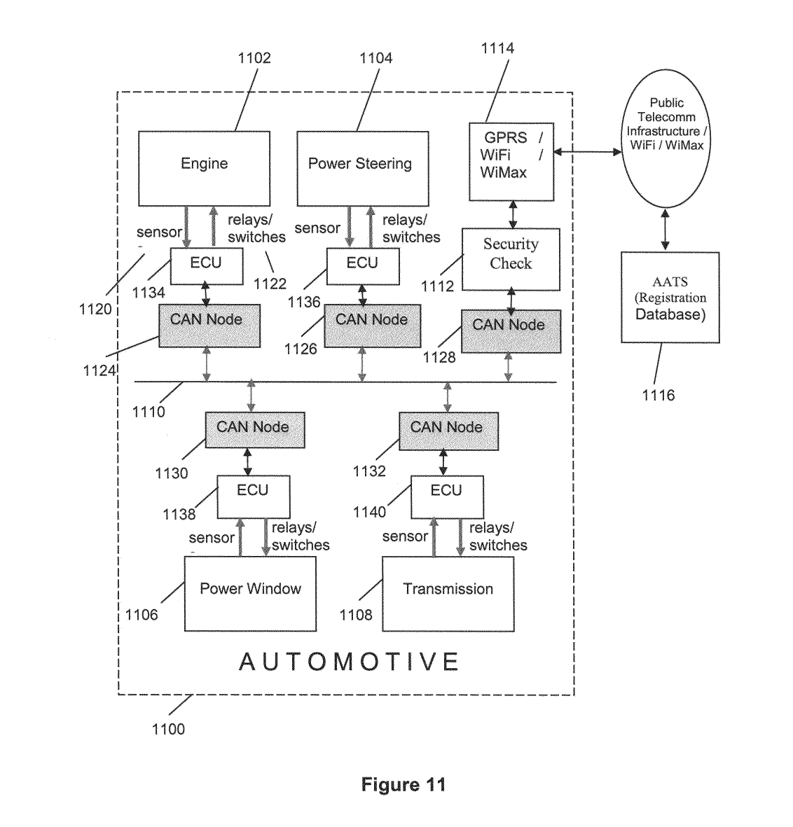

The operation of such an example embodiment is illustrated in FIG. 11. In FIG. 11, there are five systems in an automotive 1100, i.e. Engine System 1102, Power Steering System 1104, Power Window System 1106, Transmission System 1108 and Security Check System 1112 connected by a CAN Bus 1110. The Engine System 1102, Power Steering System 1104, Power Window System 1106 and Transmission System 1108 are connected to their respective ECUs 1134, 1136, 1138 and 1140. The ECUs 1134, 1136, 1138 and 1140 are in turn connected to the respective CAN nodes 1124, 1126, 1130 and 1132, which are connected to the CAN Bus 1110. The ECUs 1134, 1136, 1138 and 1140 interact with their respective systems 1102, 1104, 1106 and 1108 via sensors 1120 and through relays/switches 1122. The sensors 1120 provide feedback from the systems 1102, 1104, 1106 and 1108 to the ECUs 1134, 1136, 1138 and 1140 to regulate the operation of the systems. The relays/switches 1122 are inputs from the ECUs 1134, 1136, 1138 and 1140 to the respective systems 1102, 1104, 1106 and 1108 to activate/deactivate and/or regulate the operation of the systems. It is appreciated that the ECUs in different automotives may be connected in other ways in a CAN, for instance, like the example shown in FIG. 9.

The Security Check system 1112 is connected to a CAN node 1128 and a communication interface 1114 to communicate with a remote server 1116 via GSM (e.g. through GPRS), 3G (e.g. through WiFi) and WiMax. It is appreciated that the Security Check system 1112 is an ECU.

For tamper resistance against hackers hacking into the CAN Bus 1110, it is appreciated that data communication between the ECUs 1134, 1136, 1138 and 1140 and between the ECUs 1134, 1136, 1138 and 1140 and the Security Check system 1112 can be carried out as described above for the previous embodiments, referred to herein as Distributed Computing with Non-Stationary Code Obfuscation.

In the example embodiment, the remote server 1116 is a central server at an operation centre, which provides external automotive control as a service to many automotive owners. The remote server 1116 consists of a registration database containing information of automotive owners who subscribed to the external automotive control service and information of their automotives.

Prior to starting the engine of the automotive 1100, i.e. when the ignition key is plugged in the ignition and turned halfway to power up the electrical components of the automotive 1100, a “Request For Activation” message is broadcasted from each CAN nodes 1124, 1126, 1130 and 1132 of the four systems 1102, 1104, 1106, 1108 to the Security Check system 1112 in different time intervals. The “Request For Activation” messages contain identity information of the respective systems 1102, 1104, 1106, 1108 (e.g. serial number, part number and manufacturer name). Upon receiving the broadcasted “Request For Activation” message from one of the systems 1102, 1104, 1106, 1108, the Security Check system 1112 forwards the “Request For Activation” message to the remote server 1116 via, in this example, GSM. In the case where other servers in the external network verify the “Request For Activation” message, the “Request For Activation” message will contain the identity information of the pre-designated server and the Security Check system 1112 will forward the “Request For Activation” message to the pre-designated server based on the identity information.

Upon receiving the respective “Request For Activation” messages 1142 from the systems 1102, 1104, 1106, 1108 at the remote server 1116, if the remote server 1116 or another external server (not shown in FIG. 11), in the case of verification by other servers in the external network, confirms that one of the systems 1102, 1104, 1106, 1108 (i.e. the corresponding auto part) is installed in the right automotive, it will send a second security message referred to as “Clear For Activation” 1144 to the Security Check system 1112. The Security Check system 1112 will then forward the “Clear For Activation” message to the corresponding system in the CAN 1110. If the remote server 1116 or external server detects that a system is installed in the wrong automotive, it will not send a “Clear For Activation” message to that system. In this case, the ECU of the system will cease to function after not receiving a “Clear For Activation” message within a specified time period.

If all the “Clear. For Activation” messages 1144 are received, the Security Check system 1112 will send a third security message, “Request To Start Automotive” 1146, to the remote server 1116. If one of the “Clear For Activation” messages 1144 are not received, the automotive 1100 cannot be started.

After receiving the “Request To Start Automotive” message, if the remote server 1116 verifies that the automotive 1100 has not been reported stolen, it will send a fourth security message referred to as “Start Automotive” message to the Security Check system 1112 and the automotive engine would be started upon complete turning of the ignition key. If the server of the remote server 1116 detects that the automotive 1100 has been reported stolen, it will not send the “Start Automotive” message and the automotive engine would not be started upon complete turning of the ignition key.

If for some reason the automotive 1100 is out of range with base stations of the wireless communication technologies such as GSM, 3G or WiMax, the example embodiment allows the automotive 1100 to be started even if it does not receive explicit authorization from the external server 1116 for a limited period of time. This limited period of time is administered in the form of software credits. As long as the automotive 1100 is out of range, credits will be decremented with time. Once the automotive 1100 establishes communication again with the remote server 1116 and no theft of the automotive 1100 is reported, the number of credits will be restored to its maximum value. The optimum value of credits to be assigned can be based on the geographical location of the automotive 1100.

Example embodiments of the present invention may have the following features.

Divide on-board software of each ECU into a stationary code and a non-stationary code. Store all the Non-Stationary Codes of the ECUs in other ECUs. The Stationary Code and Non-Stationary Code of an ECU cannot be stored in the same location (ECU). Have multiple identical copies of Non-Stationary Codes for an ECU where only one Non-Stationary Code will be assigned and used to interact with the Stationary Code of the active ECU at any one time. These features enhance tamper resistance of the ECUs' software to prevent hackers from removing any anti-theft security feature.

Utilize CAN protocol or the like, which does not assign a fixed address for CAN nodes but only identify CAN frames using data identifiers. Utilize a Trusted Third Party (e.g. TPU or external server) to allocate an ECU where Non-Stationary Code resides for messages transmitted between Stationary Codes and Non-Stationary Codes in an unknown fashion. In this manner, hackers who eavesdrop on the CAN Bus will not be able to find out the ECU, in which a Non-Stationary Code is executing for. The assignment of an ECU where Non-Stationary Code resides will be different when the vehicle restarts, that is, an unknown assignment procedure by the Trusted Third Party during the starting of the automotive

Force ECUs to communicate via intermediate nodes to make it useless for a hacker to tamper only one ECU. In the case where one CAN Bus is to be used, at least two ECUs (or CAN nodes) must be tampered concurrently in order to have a chance for a successful hack into the system. In the case where more than one CAN Bus is used, and the sending and receiving ECUs are on different CAN Buses, at least three ECUs (or CAN nodes) must be tampered concurrently in order to have a chance for a successful hack into the system.

Authenticate Stationary Codes and encrypt Non-Stationary Codes in ECUs using a Trusted Third Party (e.g. TPU or external server). This helps to ensure that any attempt to remove an ECU from the CAN Bus will be detected. This in turns prevent the eavesdropper from finding out which ECU is executing a particular Non-Stationary Code. Interleave Non-Stationary Codes (of other ECUs) and Stationary Code in an ECU at the source code level, and then compile to executable code stored in the memory of the ECU. This makes it difficult for hackers to modify the software, as he will not have access to source code but only machine code (or executable code).

Alternatively, have the Trusted Third Party (e.g. TPU or external server) store all Non-Stationary Codes of the ECU and utilizing the Trusted Third Party as the intermediate node for all exchanges of messages between ECUs.

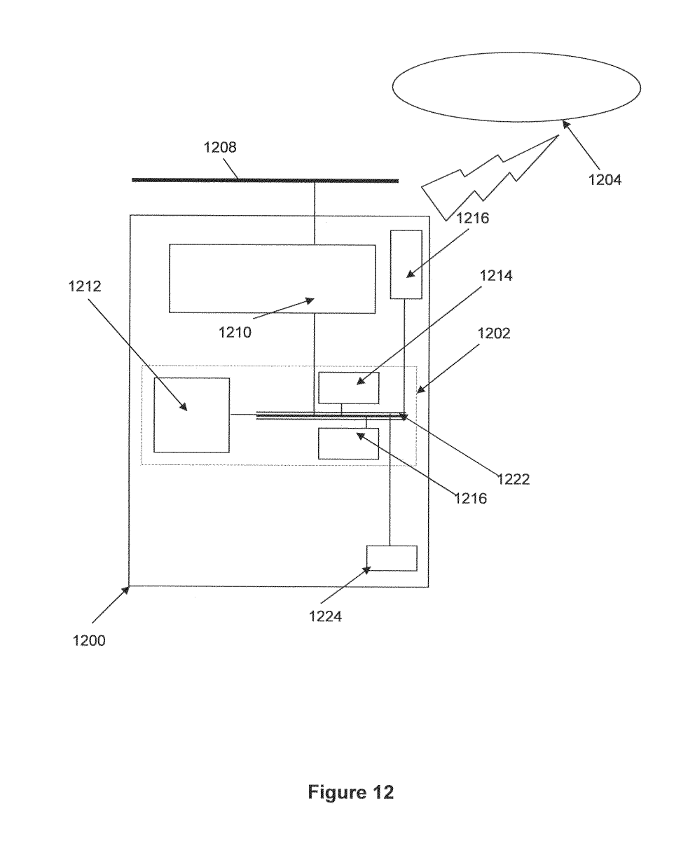

The ECU or the TPU of the example embodiments herein described can be implemented on an electronic device 1200 schematically shown in FIG. 12. It may be implemented as software, such as a computer program being executed within the electronic device 1200, and instructing the electronic device 1200 to conduct the method.

The electronic device 1200 comprises a processor module 1202. The processor module 1202 is connected to a wired network 1208, e.g. CAN, via a suitable transceiver device 1210 (e.g. a CAN node), to enable communication and/or access to other similar electronic devices in the wired network. The electronic device 1200 may also be wirelessly connected via another suitable transceiver device 1216 to devices located external to the wired network 1204. An example of an electronic device requiring the transceiver 1216 is the Security Check System 812 in FIG. 8.

The processor module 1202 in the example includes a processor 1212, a Random Access Memory (RAM) 1214 and a Read Only Memory (ROM) 1216. The components of the processor module 1202 typically communicate via an interconnected bus 1222.

The application program is typically supplied to the user of the electronic device 1200 encoded on a data storage medium such as a flash memory module 1224 or the like. The application program is read and controlled in its execution by the processor 1212. Intermediate storage of program data may be accomplished using RAM 1214.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

It is appreciated that the example embodiments herein described in the context of tamper proofing electronic devices in an automotive can be equally applied to other systems, for instance, in a system of interconnected electronic devices used for passenger cars, trucks and buses, off-highway and off-road vehicles, passenger and cargo trains, maritime electronics in boats, ships, and vessels, aircraft and aerospace electronics, factory automation, industrial machine control, lifts and escalators, building automation, medical equipment and devices, non-industrial control or equipment such entertainment and amusement structures, or the like.

1. A method for tamper proofing a system of interconnected electronic devices, the method comprising:
splitting embedded software of each electronic device into at least two executable parts, a stationary part residing in memory of said each electronic device and a non-stationary part residing in memory of another electronic device.

2. The method as claimed in claim 1, wherein the method further comprises:
interleaving at least one stationary part and one non-stationary part residing in memory of one electronic device at source code level; and
compiling the stationary part and the non-stationary part to executable code for storing in the electronic device.

3. The method as claimed in claim 1, wherein the stationary part and the non-stationary part of the split embedded software of one electronic device communicate with each other via broadcasting communications over a network bus.

4. The method as claimed in claim 1, wherein the broadcasting communications comprise data messages, and electronic devices receiving the broadcasting communication determine whether the broadcasting communication is intended for them based on the data messages.

5. The method as claimed in claim 1, wherein the data messages are encrypted.

6. The method as claimed in claim 1, wherein the system further comprises a secure device interconnected to the electronic devices.

7. The method as claimed in claim 1, wherein the secure device broadcast an authentication request for one of the electronic devices, and the secure device authenticates said one device based on a broadcast authentication reply from said one electronic device.

8. The method as claimed in claim 7, wherein the authentication is based on authentication of the stationary part of the split embedded software of said one electronic device.

9. The method as claimed in claim 7, wherein the secure device assigns the non-stationary part of said one electronic device residing in memory of another electronic device by sending an assignation request to said other electronic device.

10. The method as claimed in claim 9, wherein multiple copies of the non-stationary part of one electronic device reside in respective memories of two or more other electronic devices, and the secure device only assigns and activates one copy of the non-stationary part for each assignation instance.

11. A system for tamper proofing a system of interconnected electronic devices, the system comprising:
a plurality of electronic devices, wherein each electronic device comprises an embedded software,
said embedded software is split into at least two executable parts, a stationary part residing in memory of said each electronic device and a non-stationary part residing in memory of another electronic device.

12. The system as claimed in claim 11, wherein at least one stationary part and one non-stationary part residing in memory of one electronic device are interleaved at source code level, with the stationary part and the non-stationary part compiled to executable code stored in the electronic device.

13. The system as claimed in claim 11, wherein the stationary part and the non-stationary part of the split embedded software of one electronic device communicate with each other via broadcasting communications over a network bus.

14. The system as claimed in claim 11, wherein the broadcasting communications comprise data messages, and electronic devices receiving the broadcasting communication determine whether the broadcasting communication is intended for them based on the data messages.

15. The system as claimed in any one of claim 11, wherein the data messages are encrypted.

16. The system as claimed in any one of claim 11, wherein the system further comprises a secure device interconnected to the electronic devices.

17. The system as claimed in claim 11, wherein the secure device broadcast an authentication request for one of the electronic devices, and the secure device authenticates said one device based on a broadcast authentication reply from said one electronic device.

18. The system as claimed in claim 17, wherein the authentication is based on authentication of the stationary part of the split embedded software of said one electronic device.

19. The system as claimed claim 17, wherein the secure device assigns the non-stationary part of said one electronic device residing in memory of another electronic device by sending an assignation request to said other electronic device.

20. The system as claimed in claim 19, wherein multiple copies of the non-stationary part of one electronic device reside in respective memories of two or more other electronic devices, and the secure device only assigns and activates one copy of the non-stationary part for each assignation instance.

21. An automotive comprising the system as claimed in claim 11.
